(19) United States
(12) Patent Application Publication
(10) Pub. No.: US 2009/0045277 A1
(43) Pub. Date: Feb. 19, 2009

(54) KITCHEN IMPLEMENT WITH EXTENDABLE HANDLE

(76) Inventor: Ellis N. Shamoon, Dallas, TX (US)

Correspondence Address: Daniel V. Thompson;Thompson & Gustavson, LLP, 9304 Forest Lane, Suite N253, Dallas, TX, 75243, US

(21) Appl. No.: 11/839,005

(22) Filed: Aug. 15, 2007

(51) Int. Cl. B02C 19/00; B23Q 3/00

(52) U.S. Cl. 241/274; 269/289 R; 269/292; 269/302.1

(57) ABSTRACT

A kitchen implement has a main body including a generally-planar cutting board section. The main body further includes a strainer section adjacent the cutting board section. The kitchen implement has an integrally-formed, fixed side edge at one side of the main body. The kitchen implement has an extendable handle at another side of the main body, the handle being extendable between fully-retracted and fully-extended states.

### FIELD OF THE INVENTION

This invention relates generally to kitchenware items and, more particularly, to cutting boards.

### BACKGROUND OF THE INVENTION

During the preparation of food it is often desirable to combine the tasks of cutting and rinsing, for example, with vegetables that need to be cut into small pieces after being rinsed. It is thus known to provide a cutting board with an integral strainer section, also known as a strainer board.

It is also known to provide strainer boards with an extendable side handle, so that it may be positioned over sinks of varying dimensions. One such extendable handle strainer board, called the “BasketBoard™,” has been produced by Dexas International, Ltd. of Carrollton, Tex., USA. A drawback of this prior device is the awkward interface between the sink and the extendable handle.

Another extendable handle strainer board is disclosed in U.S. Pat. No. 6,276,675. The sink interface is offset from the plane of the cutting board section. Both sides are extendable, which would seem advantageous but in practice is awkward to use.

### SUMMARY OF THE INVENTION

A kitchen implement, in the form of a cutting board or strainer board, has an improved extendable handle structure.

### BRIEF DESCRIPTION OF DRAWINGS

A more complete understanding of the invention and its advantages will be apparent from the Detailed Description taken in conjunction with the accompanying Drawings, in which:

FIG. 1 is a perspective view;

FIG. 2 is a top view with the handle in the fully-retracted state;

FIG. 3 is a top view with the handle in the fully-extended state;

FIG. 4 is a partially broken away, partial top view, broken away at the plane of line 4-4 in FIG. 5; and

FIG. 5 is a partial side view.

### DETAILED DESCRIPTION

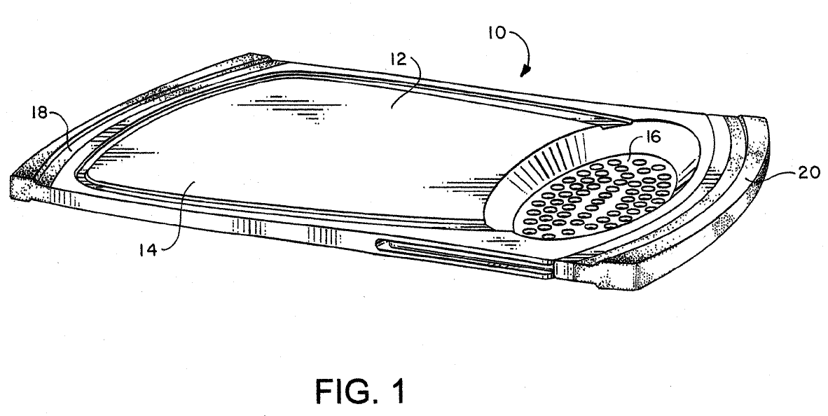

Referring to FIGS. 1-5, a kitchen implement 10 is illustrated in the form of a strainer board, though it will be recognized that the handle structure of the present invention would be useful with a cutting board (without a strainer section) as well. Implement 10 has a main body 12 including a generally-planar cutting board section 14 and a strainer section 16 adjacent the cutting board section.

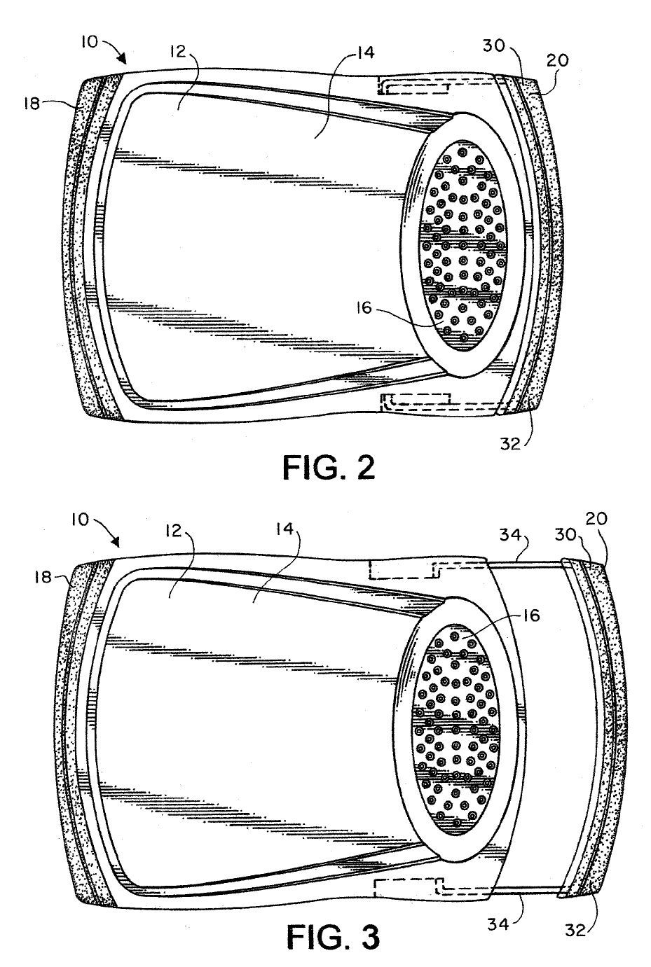

Implement having an integrally-formed, fixed side edge 18 at one side of the main body 12 and an extendable handle 20 at another side of the main body 12. As shown in FIGS. 2 and 3, handle 20 is extendable between fully-retracted and fully-extended states.

The side edge 18 and handle 20 are slightly arcuate in the plane of the cutting board section. The fixed side edge 18 is on an opposite side of the main body 12 than the strainer section 16, and the extendable handle 20 is adjacent the strainer section 16. The side edge 18 and extendable handle 20 are substantial mirror-image shapes when the handle 20 is in a fully-retracted state.

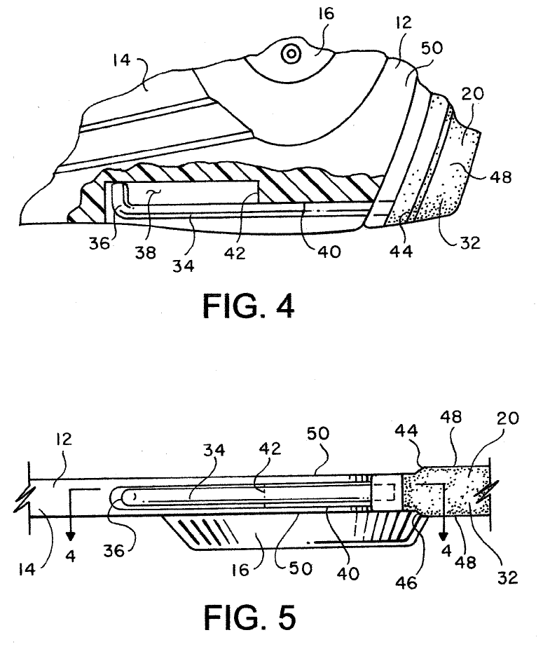

The extendable handle 20 has two ends 30, 32. A cylindrical rod 34 extends from each end 30, 32 in the direction of the main body 12, with the rods 34 each terminating at a right-angle bent tip 36 (FIG. 4) facing the other tip 36, as shown in FIGS. 4 and 5, which are typical of both ends of handle 20.

Bent tips 36 are retained in pockets 38 of the main body 12, with open walls 40 retaining the rods 34 for linear motion with respect to the main body 12, and with planar walls 42 in the pockets 38 establishing with the bent tips 36 a limit of extension of the handle 20.

The side edge 18 and handle 20 are formed with upper and lower steps 44,46 to form grip surfaces 48 more widely-separated than interior surfaces 50 of the main body 12.

In operation, the extendable handle of the present invention is remarkably superior to the prior products previously sold with an extendable handle function. The mirror-image, arcuate grips of the side edge and handle are pleasing in appearance and allow the handle to be extended to a precise position for use, then retracted for cleaning and storage. The bent tip cylindrical rods and cooperating pockets allow easy assembly and superior operative characteristics.

It will be understood that each of the elements described above, or two or more together, may also find a useful application in other types of constructions differing from the type described above.

While the invention has been illustrated and described as embodied in a particular spatter screen mounting system, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A kitchen implement, comprising:
a main body including a generally-planar cutting board section;
the main body further including a strainer section adjacent the cutting board section;
with the kitchen implement having an integrally-formed, fixed side edge at one side of the main body; and
with the kitchen implement having an extendable handle at another side of the main body, the handle being extendable between fully-retracted and fully-extended states.

2. The kitchen implement of claim 1 with the side edge and handle being arcuate in the plane of the cutting board section.

3. The kitchen implement of claim 2 with the fixed side edge being on an opposite side of the main body than the strainer section.

4. The kitchen implement of claim 2 with the extendable handle being adjacent the strainer section.

5. The kitchen implement of claim 2 with the fixed side edge being on an opposite side of the main body than the strainer section, and the extendable handle being adjacent the strainer section.

6. The kitchen implement of claim 2 with the side edge and extendable handle being substantial mirror-image shapes when the handle is in a fully-retracted state.

7. A kitchen implement, comprising:
a main body including a generally-planar cutting board section;
with the kitchen implement having an integrally-formed, fixed side edge at one side of the main body;
with the kitchen implement having an extendable handle at another side of the main body, the handle being extendable between fully-retracted and fully-extended states; and
with the side edge and handle being arcuate in the plane of the cutting board section.

8. The kitchen implement of claim 7 with the side edge and extendable handle being substantial mirror-image shapes when the handle is in a fully-retracted state.

9. The kitchen implement of claim 7 with the extendable handle having two ends, the handle including a cylindrical rod extending from each end in the direction of the main body, with the rods each terminating at a right-angle bent tip facing the other tip.

10. The kitchen implement of claim 9 with the bent tips retained in pockets of the main body, with open walls retaining the rods for linear motion with respect to the main body, and with planar walls in the pockets establishing with the bent tips a limit of extension of the handle.

11. The kitchen implement of claim 8 with the extendable handle having two ends, the handle including a cylindrical rod extending from each end in the direction of the main body, with the rods each terminating at a right-angle bent tip facing the other tip.

12. The kitchen implement of claim 11 with the bent tips retained in pockets of the main body, with open walls retaining the rods for linear motion with respect to the main body, and with planar walls in the pockets establishing with the bent tips a limit of extension of the handle.

13. The kitchen implement of claim 6 with the extendable handle having two ends, the handle including a cylindrical rod extending from each end in the direction of the main body, with the rods each terminating at a right-angle bent tip facing the other tip.

14. The kitchen implement of claim 13 with the bent tips retained in pockets of the main body, with open walls retaining the rods for linear motion with respect to the main body, and with planar walls in the pockets establishing with the bent tips a limit of extension of the handle.

15. The kitchen implement of claim 6 with the side edge and handle being formed with upper and lower steps to form grip surfaces more widely-separated than interior surfaces of the main body.

16. The kitchen implement of claim 8 with the side edge and handle being formed with upper and lower steps to form grip surfaces more widely-separated than interior surfaces of the main body.

17. A kitchen implement, comprising:
a main body including a generally-planar cutting board section;
the main body further including a strainer section adjacent the cutting board section;
with the kitchen implement having an integrally-formed, fixed side edge at one side of the main body;
with the kitchen implement having an extendable handle at another side of the main body, the handle being extendable between fully-retracted and fully-extended states;
with the side edge and handle being arcuate in the plane of the cutting board section;
with the fixed side edge being on an opposite side of the main body than the strainer section, and the extendable handle being adjacent the strainer section;
with the side edge and extendable handle being substantial mirror-image shapes when the handle is in a fully-retracted state;
with the extendable handle having two ends, the handle including a cylindrical rod extending from each end in the direction of the main body, with the rods each terminating at a right-angle bent tip facing the other tip;
with the bent tips retained in pockets of the main body, with open walls retaining the rods for linear motion with respect to the main body, and with planar walls in the pockets establishing with the bent tips a limit of extension of the handle; and
with the side edge and handle being formed with upper and lower steps to form grip surfaces more widely-separated than interior surfaces of the main body.
